(19) United States
(12) Patent Application Publication
(10) Pub. No.: US 2021/0090040 A1
(43) Pub. Date: Mar. 25, 2021

(54) ENHANCED PRIVACY SETTINGS FOR CREDIT CARDS WITH MULTIPLE USERS

(71) Applicant: Bank of America Corporation, Charlotte, NC (US)

(72) Inventors: Katherine Dintenfass, Lincoln, RI (US); Lisa D. Curry, Warwick, RI (US)

(21) Appl. No.: 16/578,509

(22) Filed: Sep. 23, 2019

(51) Int. Cl. G06Q 20/10; G06Q 20/24; G06Q 20/34

(52) U.S. Cl. CPC G06Q 20/108; G06Q 20/3572; G06Q 20/24

(57) ABSTRACT

Apparatus and methods are provided for an online banking portal having adjustable display settings for transactions executed by a credit card. The credit card may have a first user and a second user. The online baking portal may have computer-readable media for performing the method steps of storing a first display setting and a second display setting. The first display setting may define first purchase information for displaying on a user portal in connection with a credit card purchase. The second display setting may define second purchase information for displaying on a user portal in connection with a credit card purchase. The second purchase information may include less information than the first purchase information.

### FIELD OF TECHNOLOGY

Aspects of the disclosure relate to customized online banking portal displays. Specifically, aspects of the disclosure relate to customized online banking portal displays that are configured to display different amounts of credit card transaction information.

### BACKGROUND

Online banking portal displays typically provide a user with multiple details relating to his/her credit card transactions. For example, for each credit card transaction, the portal may display a purchase amount, an MCC code of the transaction, an address at which the transaction was executed, and sometimes even a phone number of the location at which the transaction was executed.

It is common for a first banking customer to share a credit card with a second banking customer. The first and second customers may both be primary account holders. The first customer may be the primary account holder and the second customer may be an authorized user of the account. Despite having entered into a financial partnership with respect to a line of credit, the first customer may not desire the second customer to view all of her/his credit card transaction information. Furthermore, the second customer may not desire the first customer to view all of his/her credit card transaction information.

It would be desirable, therefore, to provide systems and methods for providing customized online banking portal displays that are configured to display different amounts of credit card transaction information for different users of a credit card.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus that may be used in accordance with the invention;

FIG. 2 shows an illustrative method in accordance with the invention;

FIG. 3 shows an illustrative banking portal in accordance with the invention; and

FIG. 4 shows another illustrative banking portal in accordance with the invention.

### DETAILED DESCRIPTION

Apparatus and methods for providing an online banking portal having adjustable display settings for transactions executed by a credit card are provided.

The credit card may have a first user and a second user. The first user may be a primary account holder and the second user may be an authorized user. The first user and the second user may both be primary account holders.

The online baking portal may include computer-readable media for performing method steps. The method steps (hereinafter, “the methods”) may include storing a first display setting and a second display setting.

The methods described herein may be performed for two, three, four or more credit cards. Each credit card may have a third user, a fourth user, or a plurality of users. Disclosure herein relating to a first and a second user should be understood to apply to multiple users as well.

The first display setting may define first purchase information for displaying on a user portal in connection with credit card purchases executed using the credit card. For example, the first purchase information may include, for each purchase, a value of the credit card purchase, a merchant category code (“MCC”) associated with the purchase, an address at which the purchase was executed, a date on which the purchase was executed, a time at which the purchase was executed, a name of the merchant/store at which the purchase was executed, a phone number of the merchant, and/or a description of the item(s) purchased.

An MCC code may be assigned to a merchant who provides a Point of Sale (“POS”) terminal at which a credit card purchase is performed. The MCC may be assigned based on products sold by the merchant. The MCC may classify a merchant based on a primary line of business.

For example, the merchant may be assigned the MCC based on whether the merchant provides predominately goods or provides predominately services. If a merchant provides both goods and services, the MCC assigned to the merchant may correspond to the greater portion of the merchant's business.

The MCC may be associated with a taxation status. For example, if the MCC corresponds to a provider of services, a customer that purchases services from the merchant may not be required to report payments for the services to a government agency.

The MCC may be assigned by the acquirer. The acquirer may assign the MCC to the merchant at a time the merchant agrees to accept the payment instrument as a form of payment. The acquirer may assign the MCC to the merchant in response to the merchant agreeing to accept the payment instrument as a form of payment.

The merchant may be assigned multiple MCCs. For example, the merchant may provide pharmacy products and grocery products. The pharmacy products may be assigned a first MCC and the grocery products may be assigned a second MCC.

The MCC may classify the merchant based on a market segment serviced by the merchant. Exemplary MCCs and associated market segment are shown in Table 1.

TABLE 1
Illustrative MCCs and associated market segments.

| Illustrative Merchant | |
|---|---|
| Category Code (“MCC”) | Illustrative Associated Market Segment |
| 0742 | Veterinary Services |
| 4214 | Motor Freight Carriers and Trucking - |
| | Local and Long Distance, Moving and |
| | Storage Companies, and Local Delivery |
| | Services |
| 4812 | Telecommunication Equipment and |
| | Telephone Sales |
| 5047 | Medical, Dental, Ophthalmic, and |
| | Hospital Equipment and Supplies |
| 5172 | Petroleum and Petroleum Products |
| 5718 | Fireplace, Fireplace Screens, and |
| | Accessories Stores |

The second display setting may define second purchase information for displaying on a user portal in connection with credit card purchases executed using the credit card. The second purchase information may include less information than the first purchase information. The second purchase information may include a value of the credit card purchase. The second purchase information may, or may not, include an MCC code. The second purchase information may not include one or more of an address at which the transaction was executed, a name of the merchant, a time of the transaction, a date of the transaction, and a description of the good(s) purchased.

The methods may include associating the first display setting with a first user portal of the first user. When the first display setting is associated with the first user portal, the first user portal may display first purchase information in connection with credit card purchases executed by the credit card. The methods may include associating the first display setting with a second user portal of the second user. When the first display setting is associated with the second user portal, the second user portal may display first purchase information in connection with credit card purchases executed by the credit card.

The methods may include receiving a request from the first user to replace the first display setting associated with the second user portal with the second display setting. The first user may transmit this request to the banking portal by selecting from an option displayed in the first user portal.

In some embodiments, the first user may select the purchase information to be included in the second display setting. In some embodiments, the second display setting may be predetermined.

The first user may be a primary account holder of the credit card. In some embodiments, the first user may only be able to transmit this request to the banking portal if the first user is a primary account holder. The first user may be an authorized user of the credit card. In some embodiments, the first user may be able to transmit this request to the banking portal if the first user is either a primary account holder or an authorized user.

The second user may be an authorized user of the credit card. The second user may be a primary account holder.

In some embodiments, the first user may be a primary account holder and the second user may be an authorized user. In some embodiments, the first user may be an authorized user and the second user may be a primary account holder. In some embodiments, the first user and the second user may both be primary account holders.

The methods may include replacing the first display setting with the second display setting on the second user portal.

In some embodiments, the methods may not include replacing the first display setting with the second display setting on the first user portal. In these embodiments, the first user portal may be associated with the first display setting and the second user portal may be associated with the second display setting. This may reduce the amount of purchase information displayed on the second user's banking portal, and retain a full display of purchase information displayed on the first user's banking portal.

In some embodiments, the methods may include replacing the first display setting with the second display setting on the first user portal as well as the second user portal. This may reduce the amount of purchase information displayed on both the first and second user banking portals.

In some of the embodiments wherein the first display setting of the first user portal are replaced with the second display setting, the methods may include creating, for the first customer, a third user portal. The third user portal may be a new banking portal accessible to the first user.

The third user portal may be created automatically in response to the first user's request to change the display settings of the second user portal. The third user portal may be created in response to an electronic request, by the first user, to create the third user portal. The first user may input the electronic request in the first user portal. The request may be in response to a prompt from the first user portal.

The first user portal may be accessible to the first customer by a first password and a first customer username. The third user portal may be accessible to the first customer by a second password and the first customer username. The third user portal may be accessible to the first customer by a second password and a second customer name.

The methods may include associating the first user portal with the second display settings. The methods may include associating the third user portal with the first display setting. The methods may include receiving, in the online banking portal, a password and username for the third user portal. The methods may include displaying, to the first user, on the third user portal, first purchase information in connection with credit card purchases executed using the credit card. Thus, the first user now has access to two user portals: the first user portal which displays some purchase information, and a third user portal which displays more purchase information than the first user portal.

Creation of the third user portal may be used in the event that the first user is in a compromised relationship with the second user, and does not want the second user to become aware of the first user's modification of the display settings of the second user portal. Creation of the third user portal may be used in the event that the second user has access to the first user portal, for example by use of force, and the first user does not want the second user to become aware of the first user's modification of the display settings of the second user portal. Thus, by modifying the first and second user portal, an individual with accesses the first and second user portal will be unaware that the first user has access to extra data, different from the second user, via the new, third user portal.

Prior to granting the first user request to replace, on the second user portal, the first display setting with the second display setting, the methods may include accessing a social media account of the first user and accessing a social media account of the second user. If the first user and the second user are determined to be partners in a relationship, the methods may include granting the first user's request to replace the first display setting with the second display setting on the second user portal and, in some embodiments, on the first user portal as well. Exemplary relationships may include a contractual relationship, a partnership, a marriage, or any other suitable relationships.

In the event that the first user and the second user are not determined to be partners in a relationship, the methods may include denying the request from the first user to replace the first display setting associated with the second user portal with the second display setting.

The methods may include searching a social media account of the first user for one or more predetermined terms. Exemplary predetermined terms may include terms indicating a possibility of distress.

In the event that one or more predetermined terms are found in the social media account of the first user, the methods may include, one, two, or all of relaxing an out-of-state fraud alert on the credit card, removing an internal inhibitor preventing the mailing of correspondence relating to the credit card to a PO box, and removing an internal inhibitor preventing the mailing of corresponding relating to the credit card to a brick-and-mortar bank.

Prior to granting the first user request to replace, on the second user portal, the first display setting with the second display setting, the methods may include searching a social media account of the first user for one or more predetermined terms. Exemplary predetermined terms may include terms indicating a possibility of distress. In the event that no predetermined terms are found in the first user's social media account, the methods may include denying the first user's request. In the event that one, two, more, or more than a threshold value of predetermined terms are identified on the first user's social media account, the methods may include granting the first user's request to replace the first display setting with the second display setting on the second user portal and, in some embodiments, on the first user portal as well.

Prior to granting the first user request to replace, on the second user portal, the first display setting with the second display setting, the methods may include searching a database to determine if the first user has a minor child. If the first user has a minor child, the methods may include replacing the first display setting with the second display setting on the first user portal and, in some embodiments, the second user portal. If the first user does not have a minor child, the methods may include denying the request from the first user to replace the first display setting associated with the second user portal with the second display setting.

In some embodiments, the first purchase information may include a purchase amount, an MCC code and an address at which the purchase was executed. In some embodiments, the second display setting may include: (1) the first purchase information for displaying on a user portal in connection with a credit card purchase associated with an MCC code that is not included in a group of MCC codes; and (2) the second purchase information for displaying on a user portal in connection with a credit card purchase associated with an MCC code that is included in the group of MCC codes, the second purchase information including the purchase amount and not the address at which the purchase was executed.

The MCC codes in the group of MCC codes may be user-selected by the first user when inputting his request to change the display settings of the second user portal.

The group of MCC codes may include MCC codes associated with essential purchases. Exemplary essential purchases may include MCC codes for food, gas, and child-care related purchase.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. For example, the online banking portal described herein may be embodied in whole or in part as a method, a data processing system, or a computer program product. Accordingly, the invention may take the form of an entirely hardware embodiment or an embodiment combining software, hardware and any other suitable approach or apparatus.

Furthermore, such aspects, such as the online banking portal, may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, flash devices and/or any combination thereof. In addition, various signals representing data or events as described herein may be transferred between a source and a destination in the form of electromagnetic waves traveling through signal-conducting media such as metal wires, optical fibers, and/or wireless transmission media—e.g. air and/or space.

Data may move between various entities in any of the embodiments of the invention via electronic transmission or manual means. Electronic transmission may utilize email, SMS or any other suitable method. Manual exchange may utilize floppy disks, USB drives, CDs, DVDs or any other suitable mechanism.

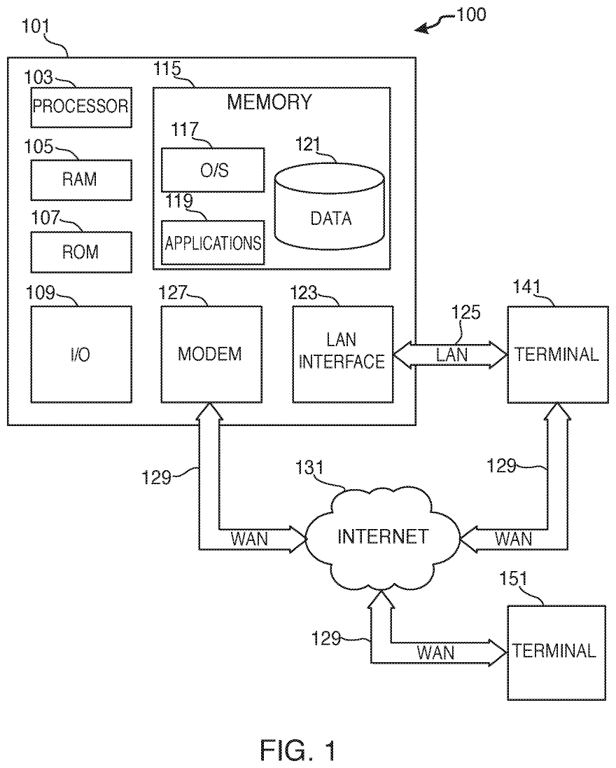

FIG. 1 is a block diagram that illustrates computing device 101 that may be used according to an illustrative embodiment of the invention. The online banking portal may include some or all of the hardware and software illustrated in connection with computing device 101. Computing device 101 may be server that provides coordinating services for a number of computing devices.

Computing device 101 may have a processor 103 for controlling overall operation of the server and its associated components, including RAM 105, ROM 107, input/output module 109, and memory 115. Computing device 101 may include one or more receiver modules, server modules and processors that may be configured to transmit and receive credit card payments, credit card payment information, wire transfers, payments via checks, debit cards, credit cards, lines of credit or any suitable credit instrument. Additionally, computing device 101 may provide confirmation to devices or terminals 141, 151.

Input/output (“I/O”) module 109 may include a microphone, keypad, touch screen, and/or stylus through which a user of computing device 101 may provide input, and may also include one or more of a speakers for providing audio output and a video display device for providing textual, audiovisual and/or graphical output. The touch screen may also serve as a video display device. The touch screen may respond to “gestures”—e.g. a double tap may open an item and a pinching motion may shrink an item. The touch screen in combination with the video display may be referred to as the “display” of the device.

Software may be stored within memory 115 to provide instructions to processor 103 for enabling computing device 101 to perform various functions. For example, memory 115 may store software used by computing device 101, such as an operating system 117, application programs 119, and an associated database 121. Alternatively, some or all of computing device 101 computer executable instructions may be embodied in hardware or firmware (not shown). As described in detail below, database 121 may provide storage for customer information, credit card purchase information for the credit card, first display settings, second display settings, user names and passwords, user portal settings, and any other suitable information.

Computing device 101 may operate in a networked environment supporting connections to one or more remote computers, such as devices 141 and 151. Devices 141 and 151 may be mobile devices, personal computers or servers that include many or all of the elements described above relative to computing device 101.

The network connections depicted in FIG. 1 include a local area network (LAN) 125 and a wide area network (WAN) 129, but may also include other networks. When used in a LAN networking environment, computing device 101 is connected to LAN 125 through a network interface or adapter 123. When used in a WAN networking environment, computing device 101 may include a modem 127 or other means for establishing communications over WAN 129 and/or Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. Both computing device 101 and mobile devices 141 and 151 may include networking hardware, networking software or a combination of hardware and software which enables communication over local area network (LAN) 125 and a wide area network (WAN) 129.

Additionally, application program 119, which may be used by computing device 101, may include computer executable instructions for invoking user functionality related to communication, such as email, short message service (SMS), and voice input and speech recognition applications.

Computing device 101 and/or mobile devices 141, 151 may also be mobile terminals including various other components, such as a battery, speaker, and antennas (not shown).

Computing device 101, terminal 151 and/or terminal 141 may be portable devices such as a laptop, cell phone, Blackberry™, smartphone, iPad™, iPhone™, Kindle™ or any other suitable device for storing, transmitting and/or transporting relevant information.

Any information described above in connection with database 121, and any other suitable information, may be stored in memory 115.

One or more of applications 119 may include one or more algorithms that may be used to perform one or more of the following: changing the display settings on user portals, determining whether or not to grant a user's request to change display settings on one or more user portals by searching social media databases or performing other decisioning processes described herein, creating at third user portal for the first user, and any other methods described herein.

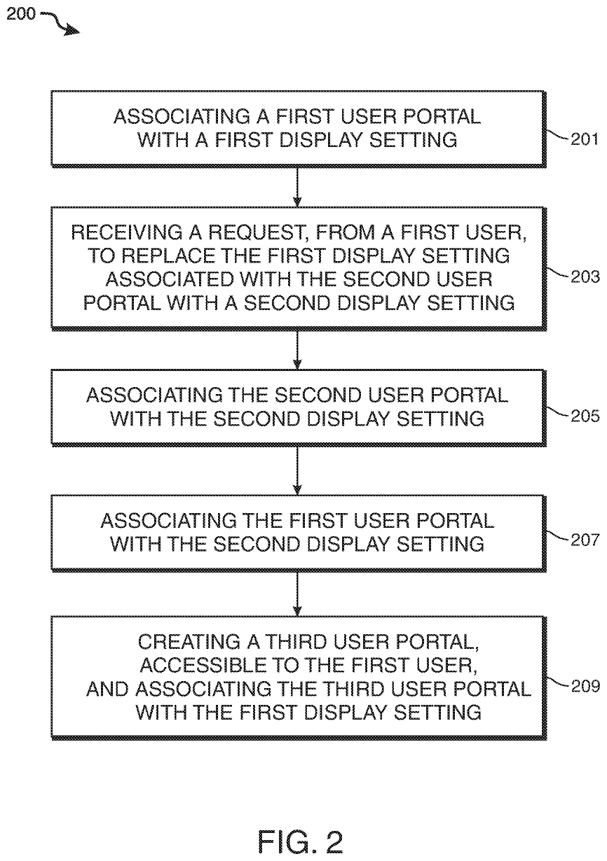

FIG. 2 shows illustrative method 200 that may be performed in accordance with the invention. At step 201, the method may include associating a first user portal and a second user portal with a first display setting. At step 203, the method may include receiving a request, from a first user, to replace the first display setting associated with the second user portal with the second display setting. At step 205, the method may include associating the second user portal with the second display setting. At step 207, the method may include associating the first user portal with the second display setting. At step 209, the method may include creating at third user portal, accessible to the first user, and associating the third user portal with the first display setting.

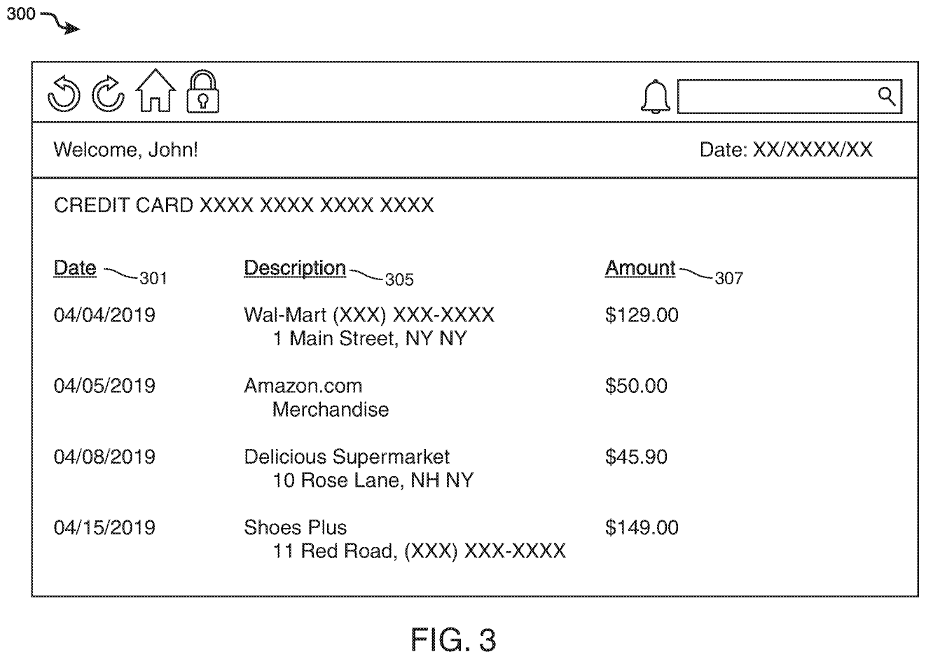

FIG. 3 shows illustrative user portal 300 associated with the first display setting. Exemplary credit card purchase information that may displayed on user portal 300, when user portal 300 is associated with the first display setting, may include date of transaction 301, description of transaction 303, and value of the purchase 305.

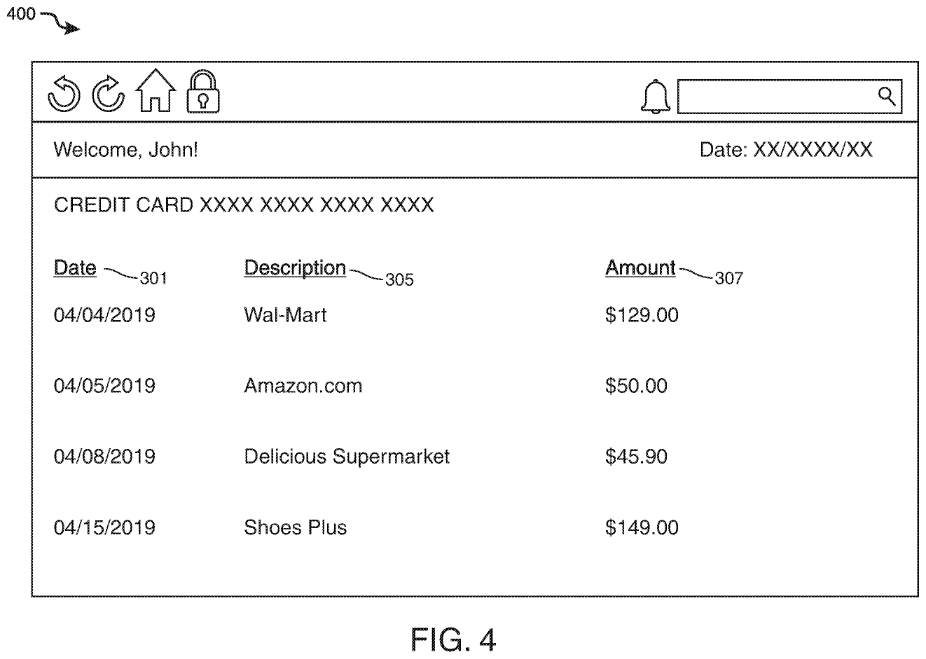

FIG. 4 shows illustrative user portal 401 associated with the second display setting. Exemplary credit card purchase information that may displayed on user portal 401, when user portal 401 is associated with the second display setting, may include date of transaction 401, modified description of transaction 403 (which does not include a location of the transaction), and value of purchase 405.

Thus, systems and methods for providing customized online banking portal displays have been provided. Persons skilled in the art will appreciate that the present invention can be practiced by other than the described embodiments, which are presented for purposes of illustration rather than of limitation.

What is claimed is:

1. An online banking portal having adjustable display settings for transactions executed by a credit card, the credit card having a first user and a second user, the online baking portal having computer-readable media for performing the method steps of:
storing a first display setting and a second display setting, wherein:
the first display setting defines first purchase information for displaying on a user portal in connection with credit card purchases executed using the credit card; and
the second display setting defines second purchase information for displaying on a user portal in connection with credit card purchases executed using the credit card, the second purchase information including less information than the first purchase information;
associating the first display setting with a first user portal of the first user and a second user portal of the second user;
receiving a request from the first user to replace the first display setting associated with the second user portal with the second display setting;
in response to the first user request, replacing the first display setting with the second display setting on the first user portal and on the second user portal;
creating, for the first customer, a third user portal, wherein:
the first user portal is accessible to the first customer by a first password and a first customer username; and
the third user portal is accessible to the first customer by a second password and the first customer username;
associating the third user portal with the first display setting;
receiving, in the online banking portal, the second password and the first customer username; and
displaying, to the first user, first purchase information in connection with credit card purchases executed using the credit card.

2. The method of claim 1 wherein the first purchase information includes:
a value of a credit card purchase;
an MCC code associated with the purchase; and
an address at which the purchase was executed.

3. The method of claim 2 wherein the second purchase information includes a value of the credit card purchase.

4. The method of claim 3 wherein the second purchase information does not include an MCC code.

5. The method of claim 3 wherein the second purchase information does not include an address at which the transaction was executed.

6. The method of claim 1 wherein the first user is a primary account holder of the credit card and the second user is an authorized user of the credit card.

7. The method of claim 1 further comprising, prior to the replacing the first display setting with the second display setting on the first user portal and on the second user portal:
accessing a social media account of the first user and accessing a social media account of the second user;
if the first user and the second user are determined to be partners in a relationship, in response to the first user request, replacing the first display setting with the second display setting on the first user portal and the second user portal; and
if the first user and the second user are not determined to be partners in a relationship, denying the request from the first user to replace the first display setting associated with the second user portal with the second display setting.

8. The method of claim 1 further comprising:
searching a social media account of the first user for one or more predetermined terms; and
if the one or more predetermined terms are found in the social media account of the first user, relaxing an out-of-state fraud alert on the credit card.

9. The method of claim 1 further comprising:
searching a social media account of the first user for one or more predetermined terms; and
if the one or more predetermined terms are found in the social media account of the first user, removing an internal inhibitor preventing the mailing of correspondence relating to the credit card to PO box.

10. The method of claim 1 further comprising:
searching a social media account of the first user for one or more predetermined terms; and
if the one or more predetermined terms are found in the social media account of the first user, removing an internal inhibitor preventing the mailing of corresponding relating to the credit card to a brick-and-mortar bank.

11. The method of claim 1 further comprising, prior to the replacing the first display setting with the second display setting on the first user portal and on the second user portal:
searching a database to determine if the first user has a minor child;
if the first user has a minor child, in response to the first user request, replacing the first display setting with the second display setting on the first user portal and the second user portal; and
if the first user does not have a minor child, denying the request from the first user to replace the first display setting associated with the second user portal with the second display setting.

12. The method of claim 11 wherein:
the first purchase information includes a purchase amount, an MCC code and an address at which the purchase was executed;
the second display setting defines:
the first purchase information for displaying on a user portal in connection with a credit card purchase associated with an MCC code that is not included in a group of MCC codes; and
second purchase information for displaying on a user portal in connection with a credit card purchase associated with an MCC code that is included in the group of MCC codes, the second purchase information including the purchase amount and not the address at which the purchase was executed; and
the group of MCC codes includes MCC codes for food, gas, and child-care related purchase.

13. An online banking portal having adjustable display settings for transactions executed by a credit card, the credit card having a first user and a second user, the online baking portal having computer-readable media for performing the method steps of:
storing a first display setting and a second display setting, wherein:
the first display setting defines first purchase information for displaying on a user portal in connection with credit card purchases executed using the credit card, the first display setting including a purchase amount, an MCC code and an address at which the purchase was executed; and
the second display setting defines second purchase information for displaying on a user portal in connection with credit card purchases executed using the credit card, the second purchase information including the purchase amount and not the address at which the purchase was executed;
associating the first display setting with a first user portal of the first user and a second user portal of the second user;
receiving a request from the first user to replace the first display setting associated with the second user portal with the second display setting;
in response to the first user request, replacing the first display setting with the second display setting on the first user portal and on the second user portal; and
creating, for the first customer, a third user portal, the third user portal being associated with the first display setting, wherein:
the first user portal is accessible to the first customer by a first password; and
the third user portal is accessible to the first customer by a second password.

14. The method of claim 13 further comprising:
receiving, in the online banking portal, the second password and a first customer username; and
displaying, to the first user, first purchase information in connection with credit card purchases executed using the credit card.

15. The method of claim 13 further comprising, prior to the replacing the first display setting with the second display setting on the first user portal and on the second user portal:
accessing a social media account of the first user and accessing a social media account of the second user;
if the first user and the second user are determined to be partners in a relationship, in response to the first user request, replacing the first display setting with the second display setting on the first user portal and the second user portal; and
if the first user and the second user are not determined to be partners in a relationship, denying the request from the first user to replace the first display setting associated with the second user portal with the second display setting.

16. The method of claim 13 further comprising:
searching a social media account of the first user for one or more predetermined terms; and
if the one or more predetermined terms are found in the social media account of the first user, relaxing an out-of-state fraud alert on the credit card.

17. The method of claim 13 further comprising:
searching a social media account of the first user for one or more predetermined terms; and
if the one or more predetermined terms are found in the social media account of the first user, removing an internal inhibitor preventing the mailing of correspondence relating to the credit card to PO box.

18. The method of claim 13 further comprising:
searching a social media account of the first user for one or more predetermined terms; and
if the one or more predetermined terms are found in the social media account of the first user, removing an internal inhibitor preventing the mailing of corresponding relating to the credit card to a brick-and-mortar bank.

19. An online banking portal having adjustable display settings for transactions executed by a credit card, the credit card having a first user and a second user, the online baking portal having computer-readable media for performing the method steps of:
storing a first display setting and a second display setting, wherein:
the first display setting defines first purchase information for displaying on a user portal in connection with credit card purchases executed using the credit card, the first purchase information including a purchase amount, an MCC code and an address at which the purchase was executed; and
the second display setting defines:
the first purchase information for displaying on a user portal in connection with a first set of credit card purchases executed using the credit card, each purchase in the first set being associated with an MCC code that is not included in a group of MCC codes; and
second purchase information for displaying on a user portal in connection with a second set of credit card purchases executed using the credit card, each purchase in the second set being associated with an MCC code that is included in the group of MCC codes, the second purchase information including the purchase amount and not the address at which the purchase was executed;
associating the first display setting with a first user portal of the first user and a second user portal of the second user;
receiving a request from the first user to replace the first display setting associated with the second user portal with the second display setting;
searching a database to determine if the first user has a minor child;
if the first user has a minor child, in response to the first user request:
replacing the first display setting with the second display setting on the first user portal and the second user portal; and
creating, for the first customer, a third user portal, the third user portal being associated with the first display setting, wherein:
the first user portal is accessible to the first customer by a first password; and
the third user portal is accessible to the first customer by a second password; and
if the first user does not have a minor child, denying the request from the first user to replace the first display setting associated with the second user portal with the second display setting.

20. The method of claim 19 wherein the group of MCC codes include MCC codes for food, gas, and child-care related purchases.
